(19) United States
(12) Patent Application Publication
(10) Pub. No.: US 2003/0032339 A1
(43) Pub. Date: Feb. 13, 2003

(54) Method of producing electrical connectors for use in downhole tools and electrical connector produced thereby

(75) Inventors: Merle L. Bell, Willis, TX (US); Daniel P. Bagley, The Woodlands, TX (US)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Greene, Tweed of Delaware, Inc., Wilmington, DE

(21) Appl. No.: 10/112,176

(22) Filed: Mar. 29, 2002

Related U.S. Application Data
(60) Provisional application No. 60/279,618, filed on Mar. 29, 2001.

(51) Int. Cl. H01R 13/405

(52) U.S. Cl. 439/736

(57) ABSTRACT

Methods of manufacturing an electrical connector for use in a downhole tool are described. The methods include placing or molding a dielectric body around a conductor, thereby forming an electrical connector. The dielectric body is composed of a composition, which itself contains a polyetherketoneketone or a derivative of polyetherketoneketone. The placement of the dielectric body around the conductor can be accomplished by molding the body around the conductor, for example, by molding techniques such as extrusion, injection molding, pressure molding, compression molding, and casting. An electrical connector for use in a downhole tool is also provided. The electrical connector contains a dielectric body and a conductor. The dielectric body includes a composition, which itself is composed of a polyetherketoneketone or a derivative of a polyetherketoneketone. The electrical connector of the invention is adapted for use in a downhole tool.

### CROSS REFERENCE TO RELATED APPLICATION

This application claims the benefit under 35 U.S.C. §119(e) of U.S. provisional patent application No. 60/279,618, filed Mar. 29, 2001, the contents of which are incorporated herein by reference.

### BACKGROUND OF THE INVENTION

Subterranean well tools (downhole tools) used in oil and gas well operations must be able to withstand the harsh environmental conditions incidental to drilling operations, including exposure to high temperatures and damaging chemicals. The onshore and offshore wells in which these tools are used have become progressively deeper and deeper, and consequently, the operating pressures and temperatures to which these tools are subject has also increased.

The environment of a drilled well is chemically and mechanically aggressive. The muds and other fluids often used to facilitate drilling contain chemical additives that can degrade the non-metallic components of downhole tools, including logging tools and drills. Such chemicals are highly caustic, with a pH level as high as 12.5. Other aggressive well fluids can include salt water, crude oil, carbon dioxide, and/or hydrogen sulfide, which are corrosive to many materials. As the depth of a given well increases, the environmental stresses (pressure, temperature, chemical attack) become greater. For example, at depths of 5,000 to 8,000 meters, bottom hole temperatures of 350° F. to 400° F. (177° C. to 204° C.) and pressures of about 15,000 p.s.i. (about 103 MPa) are common.

The downhole tools used in drilling operations are generally complex devices composed of numerous component parts. Generally, the tools are encased in a protective housing to protect interior parts of the tool. However, through the normal wear-and-tear of drilling operations, the integrity of the housing can be compromised, particularly in logging tools, the exterior housings of which are often subject to a fair amount of abrasive contact with the open well hole. Because many of these downhole tools contain electrical connectors, such connectors are necessarily subjected to the same conditions.

Under such environmental and chemical stresses, conventional glass-to-metal or ceramic-to-metal hermetically sealed connectors, each manufactured out of numerous small component parts and numerous raw materials, are particularly disadvantageous. For example, each individual component of the conventional connector must be carefully machine tooled to ensure that it will fit together precisely with the other components of the connector. Such precision tooling adds to the expense of the connector and is necessarily labor intensive. Additionally, exposure to the environment of the well may cause inconsistent or differential degradation between or among two or more of the component parts, thereby destroying the careful assemblage of parts within specific tolerances resulting in a connector that functions poorly, if at all.

In addition, because of the high temperatures to which a connector is subjected, the materials available for manufacture of each of its component parts are necessarily limited to those materials that have identical or closely similar coefficients of thermal expansion. Use of materials having significantly different coefficients of thermal expansion in the same connector will result in the physical incompatibility of the components when they undergo thermal expansion, cause the failure of the electrical connector, and, consequently, result in the malfunction of the downhole tool in which the connector is integral.

Further, the small component parts of the conventional connectors must be precisely assembled into the final product. Improper assembly can result in substandard or unacceptable electrical connectors or tolerance-stacking problems. This assembly is time consuming and labor intensive as well.

Finally, such conventional connectors are less reliable than is desirable in subterranean drilling operations, as even the slightest void or defect in the ceramic or glass dielectric body can result in catastrophic failures when the connector is in place in the downhole tool, if it is bridged and arcing to the metal conductor occurs.

To avoid the above difficulties associated with conventional glass-to-metal or ceramic-to-metal hermetically sealed connectors, electrical connectors for use in downhole tools have been produced by molding high quality thermoplastic materials around the conductors in order to completely isolate the conductor, then machine-tooling the molded material to the precise, desired tolerances. Thus far, such efforts have resulted in inadequate, unreliable or unsuccessful electrical connectors for use in downhole tools. For example, molding using polyetheretherketone (PEEK) results in a connector having unacceptable thermal and dimensional stability under the high temperature conditions of molding and processing as well as in the oilfield environment. Particularly problematic is the tendency of the shape or configuration of the tooled PEEK to degrade when exposed to high temperatures, thereby resulting in a defective electrical connector having component parts of unacceptable tolerances.

Molding with a similar material, polyetherketone (PEK), in the same manner allows for the manufacture of an electrical connector having acceptable technical attributes, but which is not suitable for widespread use because of the high cost of the PEK raw material. In addition, the molded PEK also requires substantial machine tooling in order to achieve a finished product having the precise configuration thereby increasing production costs.

Thus, there is a need in the art for an electrical connector suitable for use in downhole tools which is manufactured of materials which exhibit sufficient thermal and dimensional stability at high temperatures, which can be molded to desired tolerances, and which is made of materials sufficiently inexpensive to permit widespread use.

### BRIEF SUMMARY OF THE INVENTION

The invention described herein is directed, in one aspect, to a method of manufacturing an electrical connector for use in a downhole tool. The method includes placing a dielectric body around a conductor, thereby forming an electrical connector. The dielectric body is composed of a composition that contains a polyetherketoneketone or a derivative of polyetherketoneketone. The placement of the dielectric body around the conductor may comprise molding the body around the conductor, for example, by a molding technique such as extrusion, injection molding, pressure molding, compression molding, and casting.

The invention also provides a method of manufacturing an electrical connector for use in a downhole tool. The method includes molding a dielectric body around a conductor. The dielectric body comprises a composition, which itself contains a polyetherketoneketone or a derivative of polyetherketoneketone. The composition of the inventive method has an improved thermal stability.

An electrical connector for use in a downhole tool is also provided. The electrical connector includes a dielectric body and a conductor. The dielectric body includes a composition that is composed of a polyetherketoneketone or a derivative of a polyetherketoneketone. The electrical connector of the invention is adapted for use in a downhole tool.

The composition of the invention can contain fillers and/or blending polymers. Such fillers and/or blending polymers may include silicates, fiberglass, calcium sulfate, asbestos, boron fibers, ceramic fibers, aluminum hydroxide, barium sulfate, calcium carbonate, magnesium carbonate, fluorographite, silica, alumina, aluminum nitride, borax (sodium borate), pearlite, zinc terephthalate, Buckyballs, graphite, talc, mica, synthetic Hectorite, silicon carbide platelets, wollastonite, calcium terephthalate, silicon carbide whiskers, fullerene tubes, polyetheretherketone, polysulfones, polyether sulfones, polyetherimides, polyphenylene sulfides, thermoplastic polyimide, polysulfone/polycarbonate alloy, and liquid crystalline polymers.

### BRIEF DESCRIPTION OF THE DRAWINGS

The foregoing summary will be better understood when read in conjunction with the appended drawings. It should be understood, however, that the invention is not limited to the precise arrangements and instrumentalities shown. In the drawings:

FIG. 1 is a plan view of a male single pin electrical connector;

FIG. 2 is a cross-sectional view of the electrical connector of FIG. 1, taken along line I-I;

FIG. 3 is a plan view of a multi-pin male electrical connector;

FIG. 4 is an elevational view of the plug and socket shown in FIG. 3, taken along line 4-4;

FIG. 5 is a plan view of a hermaphroditic electrical connector; and

FIG. 6 is an end elevation view of the plug and socket of FIG. 5, taken along line 6-6.

### DETAILED DESCRIPTION OF THE INVENTION

The electrical connector of the present invention includes two primary components: (i) a conductor or conductors which may include one or more pins that are exposed to allow for connection with an electric circuit, and (ii) a dielectric body which functions as an insulator and is of a diameter sufficient to be plugged into a bulk head opening of a downhole tool.

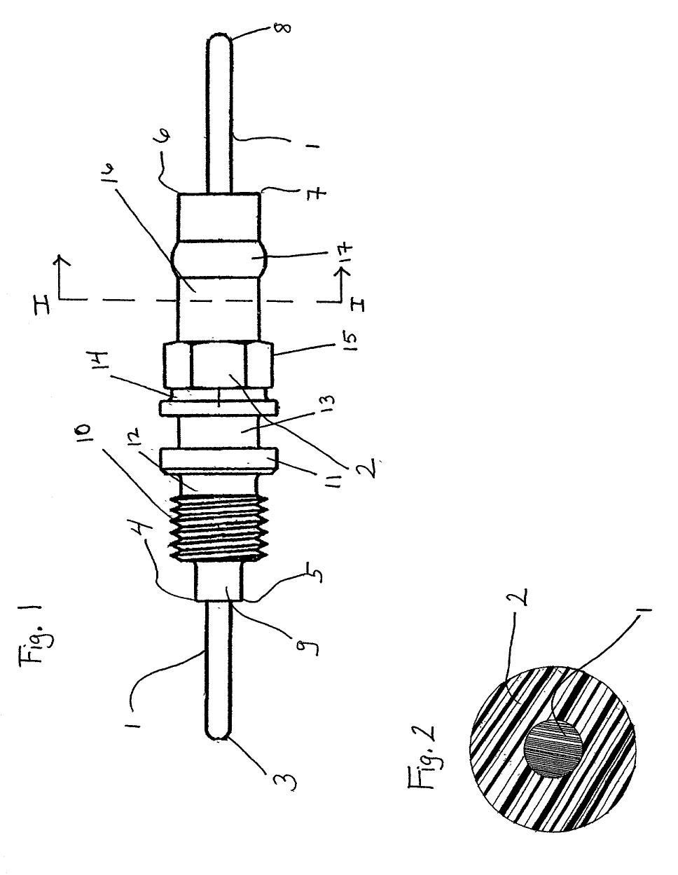

FIGS. 1-6 show exemplary electrical connectors of the invention. FIG. 1 represents a male single pin connector. The conductor 1 extends through the dielectric body 2 and terminates at each end in a male pin 3, 8. The conductor 1 includes a male pin 3 that extends longitudinally from a shoulder 4 and shoulder 5 of the dielectric body. The dielectric body also includes two shoulders 6 and 7 that define the outer edges of the dielectric body 2. A second male pin 8 extends longitudinally from the end of the dielectric body, at shoulders 6 and 7. The dielectric body 2 is an elongate, generally cylindrical member extending in length along the longitudinal axes of the dielectric body from shoulders 4, 5 and extending to shoulders 7, 8.

From the shoulders 4, 5, there extends a section 9 of the dielectric body 2 that has a relatively thin diameter measured transversely across the dielectric body immediately adjacent to the shoulders 4, 5. Adjacent this section 9, is a section 10 of the dielectric body 2, that has a relatively larger diameter than section 9 and has threads on the external surface section 9 of the dielectric body 2. Adjacent to the threaded portion 10 of the dielectric body, is a portion 11 of the dielectric body 2, that is configured with respect to section 10 and section 15 (noted below) to define recessed grooves 12, 13, and 14 into which O-rings or other sealing members may be inserted. From portion 11, the dielectric body includes section 15 having an outer surface of a generally hexagonal cross section. Adjacent to portion 15 is an elongated sleeve portion 16 that terminating in shoulders 6, 7 and includes a raised, unitary, annular member 17. The elongated sleeve portion 16 extends from a large diameter portion of the dielectric body such as, portion 11, for a sufficient length such that the electrical connector can be secured at a bulk head and yet have the insulative material of the dielectric body extending on both sides of the bulk head.

The relative thicknesses of the portions 9, 10, 11, 15, 16, 17 of the dielectric body and grooves 12, 13, 14 and the overall configuration of the dielectric body are necessarily determined by the diameter of the bulk head into which the electrical connector is to be secured. Typically, the thickness of the bulk head is equal to or less than the total length of the thickest portion of the dielectric body, for example, the portion having the largest diameter taken in the transverse direction. Accordingly, it will be understood, based upon the disclosure, that the devices shown in the figures are exemplary only, and that various designs, signs and configurations are within the scope of the invention.

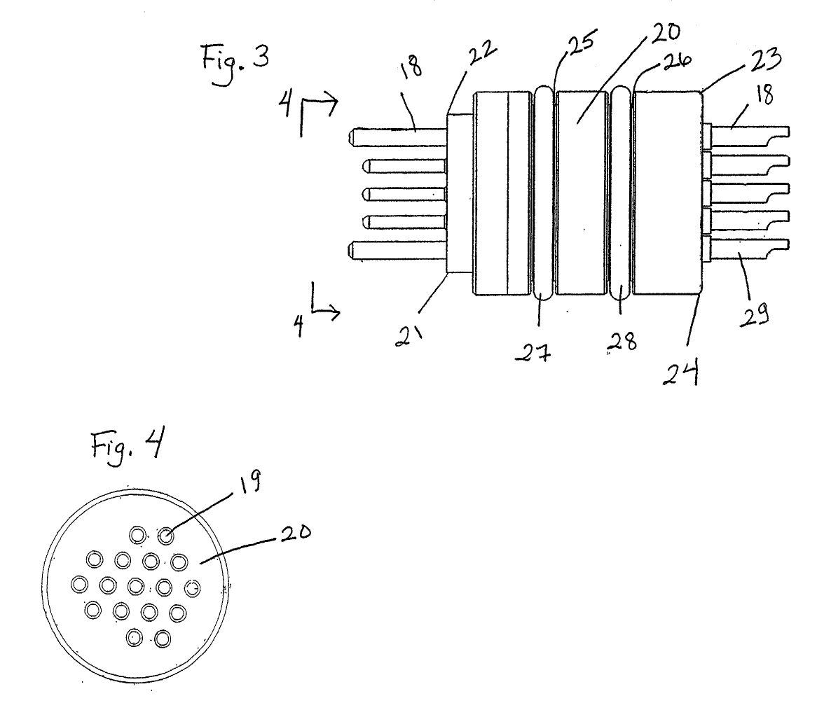

FIG. 3 represents an exemplary multipinned male connector. The connector of FIG. 3 is of a similar configuration to the connector of FIG. 1, but contains a conductor 18 having multiple male pins 19. The male pins number seventeen, as can be seen in FIG. 4, below, which are arranged in five planes; accordingly, only five are visible from the plan view shown in FIG. 3. The male pins 19 extend longitudinally from the dielectric body 20, which surrounds a portion of the conductor 18. The dielectric body extends longitudinally between shoulders 21, 22 and shoulders 23, 24. The dielectric body 20 contains two grooves 25, 26 configured to receive elastomeric O-rings 27, 28 as shown, or to receive other sealing components. The conductor 18 of the connector has multiple alignment pins 29 extending from shoulders 23, 24 of the dielectric body. Although the connector of FIG. 3 has seventeen pins, the number of pins of the connectors of the electrical connectors of the invention may contain as many or as few pins as is desirable.

FIG. 4 is a representation of an end view of the plug and socket shown in FIG. 3, having seventeen pins 19. Although the pins shown in the end view are conductor pins, a person of ordinary skill would recognize that the pins may be conductor pins or alignment pins.

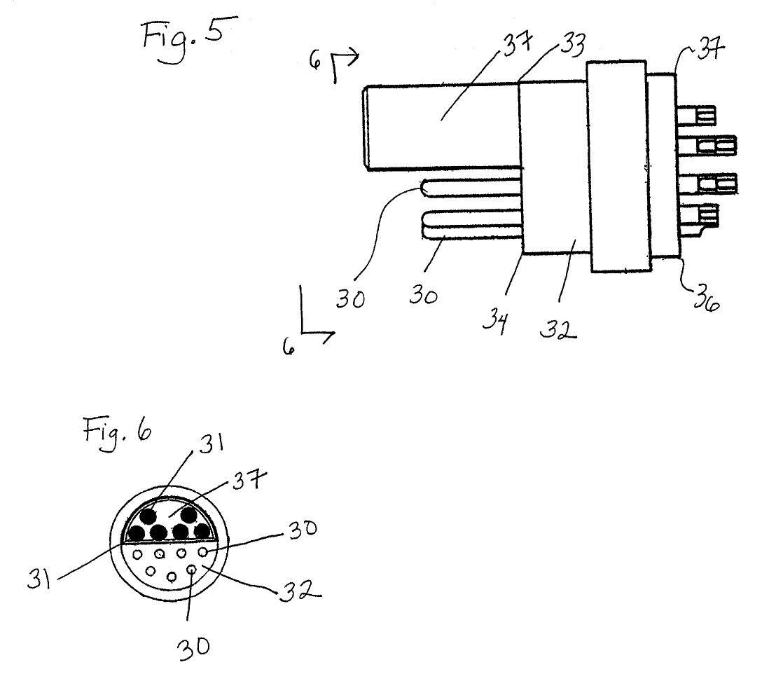

FIG. 5 is a representation of a 13-pin hermaphroditic connector. FIG. 6 is an end view of the plug and socket of FIG. 5, showing seven male pins 30 and six slots 31 into which the male pins of a corresponding electrical connector may be inserted. The connector of FIG. 4 contains a dielectric body 32, extending between shoulders 33, 34 and shoulders 35, 36 of dielectric body 37. Male pins 30 extend longitudinally from the dielectric body at shoulder 36, but, as can been seen in FIG. 5, male pins 30 are arranged on only one half of the cross-section surface of the dielectric body 32. Extending from the remaining half of the cross sectional surface is an elongated sleeve 37, preferably formed integrally with the dielectric body 32. Extending lengthwise through the sleeve 37 are seven slots 31 into which the males pins of a corresponding electrical connector may be inserted.

In both the method and connectors of the present invention, the dielectric body of the present invention includes a polyetherketoneketone (PEKK)-containing composition, which includes a PEKK or its derivatives. The applicants have found that PEKK is particularly useful in the manufacture of the dielectric body portion of electrical connectors for use in downhole tools by virtue of its physical and chemical properties, including mechanical strength and good percent elongation, which prevents the possibility of leakage to ground, high melting point (680° F./360° C.) and glass transition temperature (Tg is above 300° C.), a wide range of crystallinity, good resistance to chemical attack, low flammability and easy processability. Further, PEKK is resistant to a wide range of solvents, particularly polar solvents and exhibits high resistance to heat stress embrittlement. As illustration, comparison of the properties of polyetheretherketone (PEEK), a material used in the manufacture of conventional connectors, and PEKK is shown in Table I (each sample being a composite resin containing 30% or 40% of a carbon filler) and Table II (each sample being polymer alone (neat) or a composite resin containing 30% by weight of a glass fiber filler). The applicants have discovered that, while PEEK and PEKK resins are similarly durable and useful in downhole electrical connector applications (by virtue of similar physical and electrical properties), their differing thermal properties, in particular melting points and glass transition temperatures, make PEKK superior for use in downhole tool electrical connectors.

TABLE I
Comparison of Properties of PEKK and PEEK Composites Containing 30% or 40% Carbon

| | PEKK | PEKK | PEEK | PEEK |
|---|---|---|---|---|
| | (Crystalline) | (Crystalline) | (Crystalline) | (Crystalline) |
| | 30% By Weight | 40% By Weight | 30% By Weight | 40% By Weight |
| Property | Carbon Filler | Carbon Filler | Carbon Filler | Carbon Filler |
| General | | | | |
| Form | Pellets | Pellets | Pellets | Pellets |
| Color | Black | Black | Black | Black |
| Mold Shrinkage, in/in | 0.001 | 0.0005 | 0.003 | 0.0005 |
| Specific Gravity | 1.36 | 1.45 | 1.41 | 1.46 |
| Water Absorption @ 24 hr., % | None | None | 0.080 | 0.12 |
| Mechanical | | | | |
| Tensile Strength (Break), Kpsi | 36 | 47 | 32.8 | 39 |
| Tensile Modulus, Mpsi | 4 | 7.0 | — | 5.4 |
| Elongation (Break), % | 1.2 | 1.3 | 1 | 1 |
| Flexural Strength (Yield), Kpsi | 56 | 65 | 51.5 | 55 |
| Flexural Modulus, Mpsi | 3.5 | 4.5 | 2.9 | 3.2 |
| Izod, Notched, ft-lb/in | 1.0 | 1.8 | 1.1 | 1.6 |
| Thermal | | | | |
| Melting Point, ° F. | 680 | 680 | 649 | 644 |
| Tg (Glass Transition), ° F. | 335 | 335 | 295 | 295 |
| Flammability Rating (UL94) | V-O | V-O | V-O | V-O |
| HDT @264 psi, ° F. | >572 | >572 | >572 | >572 |

TABLE II
Comparison of PEKK and PEEK Alone (Neat) or Containing 30% Glass Fiber Filler by Weight

| | | PEKK | | PEEK |
|---|---|---|---|---|
| | PEKK | (Crystalline) | PEEK | (Crystalline) |
| | (Crystalline) | 30% By Weight | (Crystalline) | 30% By Weight |
| Property | Neat | Glass Fibers | Neat | Glass Fibers |
| General | | | | |
| Form | Pellets | Pellets | Pellets | Pellets |
| Color | Amber | Amber | Grey | Grey |
| Mold Shrinkage, in/in | 0.014 | 0.003 | 0.014 | 0.005 |
| Specific Gravity | 1.31 | 1.51 | 1.30 | 1.50 |
| Water Absorption @ 24 hr., % | <0.30 | — | 0.50 | 0.11 |
| Mechanical | | | | |
| Tensile Strength (Break), Kpsi | 16 | 27 | 13.5 | 24.9 |
| Tensile Modulus, Mpsi | 0.64 | 1.8 | 0.5 | |
| Elongation (Break), % | 12 | 1.8 | >60 | 2 |
| Flexural Strength (Yield), Kpsi | 28 | 37 | 24.7 | 33.8 |
| Flexural Modulus, Mpsi | 0.66 | 1.6 | 0.59 | 1.45 |
| Izod, Notched, ft-lb/in | — | 1.8 | 1.2 | 1.67 |
| Compressive Strength, Kpsi | 30 | — | 17 | — |
| Thermal | | | | |
| Melting Point, ° F. | 680 | 680 | 644 | 649 |
| Tg (Glass Transition), ° F. | 335 | 335 | 295 | 295 |
| Flammability Rating (UL94) | V-O | V-O | V-O | V-O |
| HDT @264 psi, ° F. | 347 | >572 | 320 | >572 |
| Limiting Oxygen Index, % | 40 | — | 35 | — |
| Thermal Conductivity | 1.75 | — | 1.73 | — |
| CTE (<Tg), 10⁻⁶ ° C. | 44 | — | 46.8 | 21.6 |
| Electrical | | | | |
| Dielectric Strength, V/mil | 600 | — | 480 | — |
| Dielectric constant @ 1 KHz | 3.30 | — | — | — |
| Dissipation Factor @ 1 KHz | 0.004 | — | — | — |

The polyetherketoneketone (PEKK) for use in the present invention is intended to encompass PEKK having any type of ring linkages, including, without limitation, para-phenylene linkages, meta-phenylene linkages or combinations thereof, depending on the particular properties or combination of properties desired in the dielectric body used in the connector.

The PEKK or PEKK derivative selected may be amorphous, crystalline, or semi-crystalline grade, depending on the specific properties desired. Particularly useful is a thermoplastic PEKK having a structure represented by the formula:

[C₆H₄OC₆H₄C(O)C₆H₄C(O)]ₙ (I)

where n may be about 30 to about 500. PEKK suitable for use in the present invention is available, for example, from Cytec Fiberite, 1300 Revolution Street, Havre de Grace, Md., 21078, U.S.A., and RTP Company, 580 East Front Street, Winona, Minn., 55987, U.S.A.

By “derivatives” of PEKK it is meant any compound that includes the PEKK backbone, as shown above, but which also has other functional group(s) or subgroup(s) attached to this backbone as to the rings. For example, a PEKK derivative may include, without limitation:

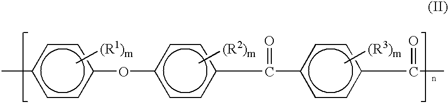

where R¹ to R³ may include aliphatic groups or heterocyclic groups, including alkyl groups, alkyne groups, alkoxy groups, alkyl groups, aldehyde groups, phenol groups, ester groups, amides or amine groups, aldehydes, ketones, or thiols. In the above formula (II), n may be about 50 to about 500, and m may be about 1 to about 12.

In an embodiment, the PEKK for use in the invention may be a copolymer of diphenyl ether and benzene dicarboxylic acid halides, preferably terephthalyl (T) or isophthaloyl (I) halides, usually chlorides, and mixtures thereof, such as is disclosed in, for example, U.S. Pat. Nos. 3,062,205; 3,441,538; 3,442,857; 3,516,966; 4,704,448; 4,816,556 and/or 6,177,518, and may contain T and I units in a ratio of 90:10 to 60:40, more preferably to 80:20, most preferably 10:30. As T units decrease and I units increase, the crystallinity of the PEKK diminishes until, at 60:40, the PEKK crystalizes so slowly that it resembles an amorphous polymer, except that it exhibits a melting point. It is preferred that the PEKK used in the composition in the present invention is a crystalline or a seim-crystalline polymer.

The dielectric body may be manufactured of PEKK polymer alone (neat PEKK) and/or derivatives of PEKK (alone) or of either of these materials containing fillers. For example, fillers which may be incorporated into PEKK and/or its derivatives to form compositions for use in the invention include, but are not limited to, glass (spheres or fibers), silicates, fiberglass, calcium sulfate, asbestos, boron fibers, ceramic fibers, polyamide fibers (such as those sold under the trademark KEVLAR®, available from E.I. du Pont de Nemours & Co., 1007 Market Street, Wilmington, Del., 19898, U.S.A.), aluminum hydroxide, barium sulfate, calcium carbonate, magnesium carbonate, silica, alumina, aluminum nitride, borax (sodium borate), activated carbon, pearlite, zinc terephthalate, Buckyballs, graphite, talc, mica, synthetic Hectorite, silicon carbide platelets, wollastonite, calcium terephthalate, silicon carbide whiskers, or fullerene tubes, depending on the specific properties desired in the end product.

Such fillers may be used to enhance the mechanical properties of the finished dielectric body or to alter or enhance other properties, thereby improving the final product or enhancing the processability, for example, by altering the Theological properties of the molten composition of the composition during molding, as desired. PEKK-containing resins containing one or more fillers, are readily available, for example, from Infinite Polymer Systems, State College, Pa., U.S.A. or from RTP Company, 580 East Front Street, Winona, Minn., 55987, U.S.A. However, neat PEKK for use in the invention may also be synthesized or purchased and subsequently compounded with a desired filler(s).

As is apparent to a person of ordinary skill in the art, the amount of filler present in the composition of the present invention may vary depending on several factors, including type of filler selected, grade or type of PEKK or PEKK derivative used, presence or absence of an additional blending polymer(s), or additives and/or any specifically desired properties of the end product. However, in general, the filler in the composition of the dielectric body may be present in the amount of about 1% to 50% by weight, about 5% to about 35% by weight, or, more preferably about 20% to about 30% by weight. A preferred filler is a glass filler (spheres or fibers).

In addition to neat PEKK polymer, and/or a PEKK containing fillers, the composition of the dielectric body of the present invention may be formed of a PEKK blended with other polymers, in addition to, or in the absence of, the above-discussed fillers. By blending, it is intended to mean that one could combine the blending polymer with the composition by any means, for example, melt mixing or physical mixing. Such polymers for blending (“blending polymers”) include any known in the art or to be developed which are useful to improve the processability or other properties, of the PEKK, such as molten viscosity, mold flow, processability, insulative capacity, and other mechanical and/or electrical properties, without significantly degrading its thermal and/or chemical stability. More specifically, useful blending polymers include, without limitation, polyetherketone (PEK), polyetheretherketone (PEEK), polysulfones (PSU), polyether sulfones (PES), polyetherimides (PEI), polyphenylene sulfides (PPS), polyphthalamide (PPA), thermoplastic polyimide (TPI), polysulfone/polycarbonate alloy (PSU/PC), and/or liquid crystalline polymers (LCPs), all of which are commercially available from, for example, RTP Company, 580 East Front Street, Winona, Minn., 35987, U.S.A. While those of ordinary skill in the art will appreciate that the amount of blending polymer present in the composition will vary depending on the properties desired, it is generally preferred that the blending polymer is present in an amount of about 2% by weight to about 20% by weight, with a more preferred amount of about 5% by weight to about 15% by weight and a most preferred amount of about 7% by weight to about 10% by weight of the total composition.

Additives may be incorporated into the composition from which the dielectric body is formed, in order to modify any of the properties, of the finished body or the non-annealed or molten plastic composition. Such additives can include, for example, lubricating agents, thixtropic agents, UV-stabilizers, antistatic agents, viscosity-reducing agent, and/or flame retardants.

If other than neat PEKK (PEKK alone) and/or its derivatives is to be used in the composition, the PEKK and/or its derivatives can be compounded or mixed with the selected filler(s) and/or selected blending polymer(s) using any mixing or compounding methods known or to be developed in the art, such as extrusion, mixing, and melt mixing.

Regardless of whether the composition is PEKK neat, or contains filler(s) and/or blending polymer(s), the composition used in the electrical connectors may exhibit, at minimum, a glass transition temperature (Tg) of about 250° F. to about 500° F. (about 121° C. to about 260° C.); preferably the Tg of the composition is greater than about 300° F. (about 150° C). The glass transition temperature of the composition allows for improved processability when the component is found by molding techniques. The applicants have discovered that compositions of higher glass transition temperatures exhibit, for example, improved mold flow and viscosity at molding temperatures than materials of lower glass transition temperatures.

The conductor for use in the present invention may have the configuration of any conductor known or to be developed for use in electrical connectors, such as, for example, those disclosed in the electrical connectors of U.S. Pat. Nos. 6,358,100; 6,358,088; 6,358,085; D454,543; 6,355,884; 6,354,886; D454,355; 6,352,450; D454,115; D454,114; D454,113; the contents of each of which are incorporated herein by reference. The conductor may be a male conductor (single pin or multipin), a female conductor, or a hermaphroditic conductor, as shown in FIGS. 1-6, and described above. They may be coaxial or rotatable. The conductor may be formed to contain threads, ridges or grooves, if desired.

Conductors for use in the invention may be produced using any means known in the art, including, for example, production by automatic screw machines. As is known in the art, the pin(s) of a finished male electrical connector should be of a uniform and consistent size to ensure proper contact(s). The male pin(s) of the male conductors for use in the electrical connectors of the invention may be of any diameter known in the art and will vary depending on the requirements of the tool into which the electrical connector is to be incorporated, although diameters of about 0.125 inches and about 0.050 inches are preferred, diameters of about 0.094 to about 0.047 inches are more preferred. Of course, it is understood that the diameter(s) of the pin(s) will vary, depending on the specific tool or application within the tool for which the specific electrical connector is intended.

Materials from which the conductor may be made can include any conductive material know or developed in the art. Preferred are metal alloys, such as, for example, nickel alloys, steel alloys, copper alloys, chromium nickel alloys, aluminum alloys, and silver alloys. The conductor may consist of one such material, or may contain more than one of the materials. For example, a conductor may consist of a first conducting material and may be plated or coated with an additional material(s), such as, for example, a gold-plated copper alloy conductor or a gold-plated chromium nickel alloy conductor.

Metal alloys of which the conductor can be made include, but are not limited to: (i) beryllium copper alloys; (ii) nickel silver alloys; (iii) chromium nickel alloys, for example, the alloys sold under the trademark INCONEL® 750 or INCONEL® 718, available from, for example, High Performance Alloys, Inc., 444 Wilson Street, Tipton, Ind., 46072, U.S.A., (iv) aluminum alloys, such as the alloy sold under the trademark ALUMEL®, Hoskins Manufacturing Company, 10776 Hall Road, Hamburg, Mich., 48139, U.S.A., (v) chromium alloys, such as the alloy sold under the trademark CHROMEL® available from Hoskins Manufacturing Company, and (vi) stainless steel. Alloys preferably meet the specifications set forth in the industry, for example, as described in ASTM B196 (2001) (beryllium copper alloy); ASTM B151 (2001) (nickel silver alloy); AMS 5698 (2001) (INCONEL® X750); AMS 5643 (17-4 PH stainless steel) (2001)); and ASTM A276 (2001) (316 stainless steel), the contents of each of which are incorporated herein by reference. Preferred are conductors made of beryllium copper or of INCONEL® 718 (chromium nickel alloy).

The dielectric body may be of any desirable configuration, including, but not limited to, those configurations known and developed in the art for use as electrical connectors. Exemplary configurations, include, but are not limited to, those shown in FIGS. 1-6, herein, and disclosed in U.S. Pat. Nos. 6,358,100; 6,358,088; 6,358,085; D454,543; 6,355,884; 6,354,886; D454,355; 6,352,450; D454,115; D454,114; D454,113; the contents of each of which are incorporated herein by reference.

The dielectric body may be formed or molded by any process known in the art. Exemplary processes include, but are not limited to, extrusion, injection molding, flash molding, pressure molding, transfer injection stretch molding, compression molding (wet or dry), and/or casting. The dielectric body may be molded to have substantially its finished configuration, or may be molded to a configuration having the substantially the contours of the desired finished configuration, and may be subsequently machined to its final configuration. It is preferred that the dielectric body is molded as a unitary part, as the presence of seams may affect the insulative capacity of the body under extreme downhole conditions.

It is preferred that the dielectric body of the invention is formed by injection molding, using, for example, a preplasticizing reciprocating screw or a plunger machine. Use of screw machine can provide a more homogenous melt and is therefore preferred.

The dielectric body may be molded first, and subsequently placed around a conductor, to which it is sealed. Preferably, the electrical connector is formed by overmolding the composition onto the selected conductor. By “overmolding” it is meant that the composition is placed in an uncured state over or around the conductor, molded or formed into substantially the desired end configuration, or into a configuration having substantially the contours of the desired end configuration, and subsequently dried. Overmolding may be accomplished by any molding procedures known or to be developed in the art including, without limitation, extrusion, injection molding, pressure molding, transfer injection stretch molding, compression molding, casting, and others. Examples of molding procedures are described, for example in Rodriguez, F., Principles of Polymer Systems, 3^{rd} ed., Hemisphere Pub., New York: 1989, at pp. 389-403, the contents of which are incorporated herein by reference. However, any suitable molding technique may be used. After cooling, the overmolded configuration may then be machined to a desired configuration and/or tolerance(s), if necessary or desirable.

For example, to form an electrical connector in accordance with the invention, a reciprocating screw injection molding machine or a plunger injection molding machine can be used. The mold may be a unitary mold, or a mold composed of two or more pieces. It is preferred that the dielectric body is overmolded onto the electrical conductor. To accomplish this, it is preferable to place the selected conductor within the mold cavity prior to the injection of the composition into the mold.

If injection molding is to be performed, the selected composition can be fed from a hopper into the heated barrel of the injection molding machine. It is preferred that the barrel is heated to a temperature of about 725° F. to about 770° F. (about 385° C. to about 410° C.) prior to the introduction of the composition. The composition is permitted to reside in the barrel until a homogenous melt is achieved.

Once the composition is molten, it is preferred that the barrel temperature is held at about 20° F. to about 55° F. (about 10° C. to about 30° C.) above the melting point of the composition during the injection process. To accomplish the injection process, the composition is forced into the mold by a screw or ram. A two-stage injection process is preferred, in order to allow for the minimization of “molded-in” stresses, although a one-stage process may be used. It is preferred that the surface temperature of the mold is about 355° F. to about 375° F. (about 180° C. to about 190° C.), in order to achieve good mold filling characteristics and a high degree of crystallinity in the finished product.

During the duration of the injection process, it is preferred that the mold is maintained at a mold pressure of about 10,000 p.s.i. to about 20,230 p.s.i. (about 70 MPa to about 140 MPa). Upon completion of the injection process, the mold pressure is maintained until the dielectric body has dried. During this cooling (holding) period, the mold remains under pressure. It is preferred that the holding pressure of the mold is maintained at about 5,800 p.s.i. to about 14,500 p.s.i. (about 40 MPa to about 100 MPa).

The resultant electrical connector may then be subjected to additional processes to further enhance the capacity of the electrical connector to withstand extremes of chemical attack and/or environmental stress, as are commonly performed in the art. Such processes, referred to herein as “post-mold annealing processes,” include all those known and/or developed in the art, including, for example, thermal treatments to reduce residual stresses, to increase the crystallinity of PEKK composition, and/or to otherwise improve upon or modify/manipulate the mechanical or chemical properties of the composition.

The electrical connectors of, or manufactured by the method of, the present invention may be used in any downhole tool applications, including logging tools and sample tools. Examples of such tools can be found in U.S. Pat. Nos. 5,156,220; 5,309,993; and 5,316,084, incorporated herein by reference.

### EXAMPLE 1

A male, single pin electrical connector is fabricated as follows: A commercially available PEKK-containing composite composition, having 40% (by weight) glass fibers, is obtained (RTP™4105, available from RTP Company, 580 East Front Street, Winona, Minn., 55987, U.S.A.). A male, single pin conductor of beryllium copper alloy is obtained. The conductor is placed in a two-piece mold secured within the injection molding machine. The composition is overmolded onto the conductor by an injection molding process using a reciprocating screw injection molding machine under the following conditions:

| | |
|---|---|
| Temperatures: | |
| Barrel Temperature | 720° F. (382° C.) |
| Mold Surface temperature | 430° F. (221° C.) |
| Pressures: | |
| Injection pressure (stage 1) | 15,000 p.s.i. (103 MPa) |
| Injection pressure (stage 2) | 12,500 p.s.i. (86 MPa) |
| Hold Pressure | 9,000 p.s.i. (62 MPa) |
| Back Pressure | 50 p.s.i (0.34 MPa) |
| Speeds: | |
| Fill (Injection) Speed | 2 inches/sec (51 mm/sec) |
| Screw Speed | 75 r.p.m. |
| Cooling: | |
| Time and Temperature | 3 hours @300° F. (3 hours @149° C.) |
| Dew Point | −20° F. (−29° C.) |

After hardening, the electrical connector is removed from the mold, and is subjected to a post-mold annealing process in which the connector is left in an air oven for 30 minutes at 250° F. (430° C.).

The resultant molded dielectric body exhibits the following physical properties, as shown in Table III.

TABLE III

| | | As Determined |
|---|---|---|
| (1) | | by ASTM |
| Property | | Test (2001) |
| Performance | | |
| Specific gravity | 1.51 | D-792 |
| Mechanical | | |
| Impact Strength (izod), | 85 J/m | D-256 |
| notched 3.18 mm | | |
| section | | |
| Impact Strength (izod), | 801 J/m | D-256 |
| Unnotched 3.18 mm | | |
| Section | | |
| Tensile Strength | 175.8 MPa | D-683 |
| Tensile Elongation | 2% | D-683 |
| Tensile Modulus | 11700 MPa | D-683 |
| Flexural Strength | 262 MPa | D-790 |
| Flexural Modulus | 11000 MPa | D-790 |
| Thermal | | |
| Deflection temperature | Maximum 326° C. | D-648 |
| @ 1.82 MPa | | |

The connector has the physical and electrical properties and chemical resistance suitable for use in a downhole tool.

It will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined by the appended claims.

We claim:

1. A method of manufacturing an electrical connector for use in a downhole tool, the method comprising placing a dielectric body around a conductor, thereby forming an electrical connector, wherein the dielectric body comprises a composition, and the composition comprises a polyetherketoneketone or a derivative of a polyetherketoneketone.

2. The method of claim 1, wherein the composition comprises a polyetherketoneketone or a derivative of a polyetherketoneketone having a structure represented by a formula (I):
[C₆H₄OC₆H₄C(O)C₆H₄C(O)]ₙ (I)
wherein is about 30 to about 500.

3. The method of claim 1, wherein the composition comprises a polyetherketoneketone or a derivative of a polyetherketoneketone having a structure represented by a formula (II): 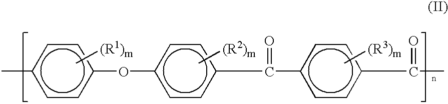
wherein R¹ to R³ are each independently selected from aliphatic groups, heterocyclic groups, alkyl groups, alkyne groups, alkoxy groups, alkenyl groups, aldehyde groups, phenol groups, ester groups, amides or amine groups, aldehydes, ketones, and thiols, n is about 50 to about 500, and m is about 1 to about 12.

4. The method of claim 1, comprising placing the dielectric body around the conductor by molding the dielectric body around the conductor.

5. The method of claim 4, further comprising the step of subjecting the resultant electrical connector to a post-mold annealing process.

6. The method of claim 4, comprising molding the dielectric body around the conductor by use of a molding technique selected from the group consisting of extrusion, injection molding, pressure molding, compression molding, and casting.

7. The method of claim 1, wherein the composition further comprises a filler.

8. The method of claim 7, wherein the filler is selected from the group consisting of glass fibers, glass spheres, and polyamide fibers.

9. The method of claim 7, wherein the filler is selected from the group consisting of silicates, fiberglass, calcium sulfate, asbestos, boron fibers, ceramic fibers, aluminum hydroxide, barium sulfate, calcium carbonate, fluorographite, magnesium carbonate, silica, alumina, aluminum nitride, borax, pearlite, zinc terephthalate, Buckyballs, graphite, talc, mica, synthetic Hectorite, silicon carbide platelets, wollastonite, calcium terephthalate, silicon carbide whiskers, and fullerene tubes.

10. The method of claim 7, wherein the composition comprises the filler in an amount of about 1% to about 50% by weight of the total composition.

11. The method of claim 7, wherein the composition comprises the filler in an amount of about 5% to about 35% by weight of the total composition.

12. The method of claim 7, wherein the composition comprises the filler in an amount of about 20% to about 30% by weight of the total composition.

13. The method of claim 1, wherein the conductor comprises an alloy selected from the group consisting of beryllium copper alloy, nickel silver alloy, nickel titanium alloy, and stainless steel.

14. The method of claim 1, wherein the composition further comprises a blending polymer selected from the group consisting of polyetherketone, polyetheretherketone, polysulfones, polyether sulfones, polyetherimides, polyphenylene sulfides, polyphthalamide, thermoplastic polyimide, polysulfone/polycarbonate alloy, and liquid crystalline polymers.

15. The method of claim 1, wherein the composition further comprises a blending polymer in an amount of about 2% by weight to about 20% by weight of the total composition.

16. The method of claim 1, wherein the composition further comprises a blending polymer in an amount of about 5% by weight to about 15% by weight of the total composition.

17. The method of claim 1, wherein the composition further comprises a blending polymer in an amount of about 7% by weight to about 10% by weight of the total composition.

18. The method of claim 1, wherein the electrical connector is selected from the group consisting of a single-pin connector, a multi-pin connector, a male connector, a female connector, a rotatable connector, and a hermaphroditic connector.

19. A method of manufacturing an electrical connector for use in a downhole tool, the method comprising molding a dielectric body around a conductor, wherein the dielectric body comprises a composition, and the composition comprises a polyetherketoneketone or a derivative of a polyetherketoneketone, wherein the composition is characterized by an improved thermal stability.

20. The method of claim 19, wherein comprising molding the dielectric body around the conductor by a molding technique selected from the group consisting of extrusion, injection molding, pressure molding, compression molding, and casting.

21. An electrical connector for use in a downhole tool comprising a dielectric body and a conductor, wherein the dielectric body comprises a composition that comprises a polyetherketoneketone or a derivative of a polyetherketoneketone, and the electrical connector is adapted for use in a downhole tool.

22. The electrical connector of claim 21, wherein the dielectric body is molded around the conductor.

23. The electrical connector of claim 21, wherein the composition comprises a polyetherketoneketone or a derivative of a polyetherketoneketone having a structure represented by a formula (I):
[C₆H₄OC₆H₄C(O)C₆H₄C(O)]ₙ (I)
wherein n is about 30 to about 500.

24. The electrical connector of claim 21, wherein the composition comprises a polyetherketoneketone or a derivative of a polyetherketoneketone having a structure represented by a formula (II): 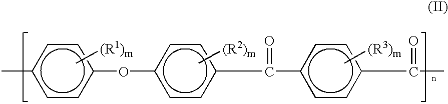
wherein R¹ to R³ are each independently selected from aliphatic groups, heterocyclic groups, alkyl groups, alkyne groups, alkoxy groups, alkyl groups, aldehyde groups, phenol groups, ester groups, amides or amine groups, aldehydes, ketones, and thiols, n is about 50 to about 500, and m is about 1 to about 12.

25. The electrical connector of claim 21, wherein the dielectric body is molded around the conductor by a molding technique selected from the group consisting of extrusion, injection molding, pressure molding, compression molding, and casting.

26. The electrical connector of claim 21, wherein the electrical connector is selected from the group consisting of a single-pin connector, a multi-pin connector, a male connector, a female connector, a rotatable connector, and a hermaphroditic connector.

27. The electrical connector of claim 21, wherein the composition further comprises a filler selected from the group consisting of glass fibers, glass spheres, and polyamide fibers.

28. The electrical connector of claim 21, wherein the composition further comprises a blending polymer selected from the group consisting of polyetherketone, polyetheretherketone, polysulfones, polyether sulfones, polyetherimides, polyphenylene sulfides, polyphthalamide, thermoplastic polyimide, polysulfone/polycarbonate alloy, and liquid crystalline polymers.
